(19) United States
(12) Patent Application Publication
(10) Pub. No.: US 2012/0201971 A1
(43) Pub. Date: Aug. 9, 2012

(54) METHOD OF COALESCING TRANSPARENT SUBSTRATE AND DISPLAY DEVICE AND DAM PATTERN FORMING APPARATUS

(75) Inventor: Seung Myoung Ryu, Chungcheongbuk-do (KR)

(73) Assignee: DMK CO., LTD., Chungcheongnam-do (KR)

(21) Appl. No.: 13/242,659

(22) Filed: Sep. 23, 2011

(30) Foreign Application Priority Data
Feb. 7, 2011 (KR) 10-2011-0010591
Mar. 7, 2011 (KR) 10-2011-0019820
Apr. 22, 2011 (KR) 10-2011-0037735

(51) Int. Cl. B05D 3/06; B05C 11/02; B05D 5/10

(52) U.S. Cl. 427/535; 427/207.1; 427/559; 118/102

(57) ABSTRACT

Provided is a method of coalescing a transparent substrate and a display device. The method includes a first step of applying light curing-type dam material on a surface of the display device and forming dam patterns, a second step of applying adhering material inside the dam patterns, and a third step of coalescing the transparent substrate on the adhering material.

### CROSS-REFERENCE(S) TO RELATED APPLICATION

This application claims priority of Korean Patent Application Nos. 10-2011-0010591, filed on Feb. 7, 2011, 10-2011-0019820, filed on Mar. 7, 2011 and 10-2011-0037735 filed on Apr. 22, 2011 in the Korean Intellectual Property Office, which is hereby incorporated by reference in its entirety into this application.

### BACKGROUND OF THE INVENTION

1. Field of the Invention

The present invention relates to a fabrication method and a related device for increasing efficiency of a coalescing method of a transparent substrate and a display device.

2. Description of the Related Art

In general, a display device may include mainly a panel for displaying image information through electric signals, a bezel for surrounding the panel, and a back light for irradiating light to the panel for the image information to be displayed thereon.

In addition, a glass may be seated on an upper surface of the panel to protect it and an adhesive agent may be applied to the upper surface of the panel to adhere the glass to the panel.

FIG. 1 is a view of applying processes of the adhesive agent to a display device according to a prior art. That is, a technology has been known that an adhesive agent P for adhering a glass C to a thin film display device L is applied on the thin film display device to avoid a reflection therefrom. However, when the liquid adhesive agent is applied on an entire front surface of the thin film display device L, bubbles A may be formed during an attaching process of a cover glass C such as TSP, Glass and plastic, etc., and thereby increasing defection rate and decreasing yield. These bubbles may be formed during the attaching process of the thin film display device and the cover glass, or may be formed from dissolved oxygen contained inside the adhering agent, which are invisible initially at a micro bubble level and grown or clustered later by an external heating environment, and thereby making products to be defective.

### SUMMARY OF THE INVENTION

An aspect of the present invention is directed to provide a process technology through which bubbles produced during a attaching process of a transparent substrate and a display device and bubbles caused from dissolved oxygen inside an adhering agent, which may cause bubble defects when an liquid adhesive agent is applied entirely on the display device for avoiding reflection, are removed completely through a plasma treatment, application process treatment and autoclave treatment, and thereby implementing reliable product, full automatic process and maximizing productivity.

According to an embodiment of the present invention, a method of coalescing a transparent substrate and a display device comprises a first step of applying light curing-type dam material on a surface of the display device and forming dam patterns, a second step of applying adhering material inside the dam patterns, and a third step of coalescing the transparent substrate on the adhering material. In particular, the method further comprises, after the third step, a fourth step of applying heat or pressure to the coalesced part of the transparent substrate and the display device to remove remaining bubbles. The dam patterns may be formed continuously through the following apparatus.

In more detail, a dam pattern forming apparatus for coalescing the transparent substrate and the display device, comprises a table on which a display device is seated, a rod module which is provided on the table and is moved along circumferential surface of the display device, and a dam forming module which is provided on the rod module and is moved continuously along entire circumferential surface of the seated display device to inject and cure the sealant simultaneously.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is a view of showing applying processes of an adhering agent on a display device according to a prior art;

FIG. 2 is a view of showing bubble removing processes in order according to an embodiment of the present invention;

FIG. 3 is a view of showing the bubble removing processes in detail according to an embodiment of the present invention;

FIG. 4(a) and FIG. 4(b) are compared images of after and before plasma treatment;

FIGS. 5 and 6 are views of showing adhesive agent application methods according to an embodiment of the present invention, respectively;

FIG. 7 is a view of showing remaining bubble treatment processes according to an embodiment of the present invention;

FIG. 8 is a perspective view of a dam pattern forming apparatus according to an embodiment of the present invention;

FIG. 9 is a perspective view of a dam forming means according to an embodiment of the present invention

FIGS. 10 and 11 are perspective views of the dam forming means shown in FIG. 9 according to another embodiment of the present invention, respectively;

FIGS. 12 and 13 are views of showing operations of the dam forming apparatus according to an embodiment of the present invention, respectively.

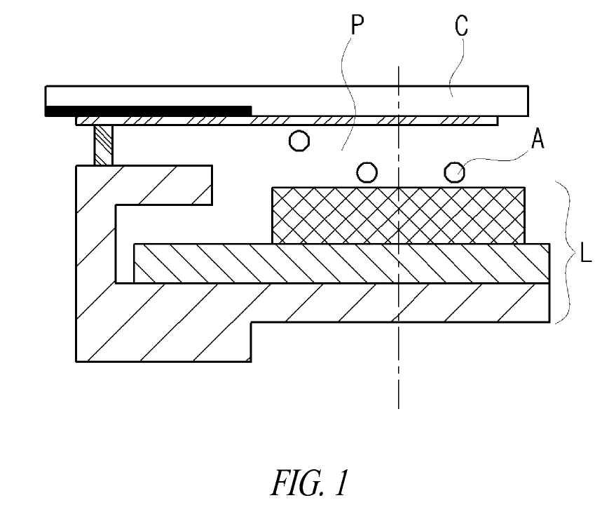

### REFERENCE NUMERALS

110: thin film display device

120: dam

X1-X4, Y1-Y4: vent hole

210: squeeze device

### DETAILED DESCRIPTION OF EXEMPLARY EMBODIMENTS

Exemplary embodiments of the present invention will be described below in detail with reference to the accompanying drawings. Wherever possible, the same reference numerals will be used to refer to the same elements throughout the specification, and a duplicated description thereof will be omitted. It will be understood that although the terms “first”, “second”, etc. are used herein to describe various elements, these elements should not be limited by these terms. These terms are only used to distinguish one element from another element.

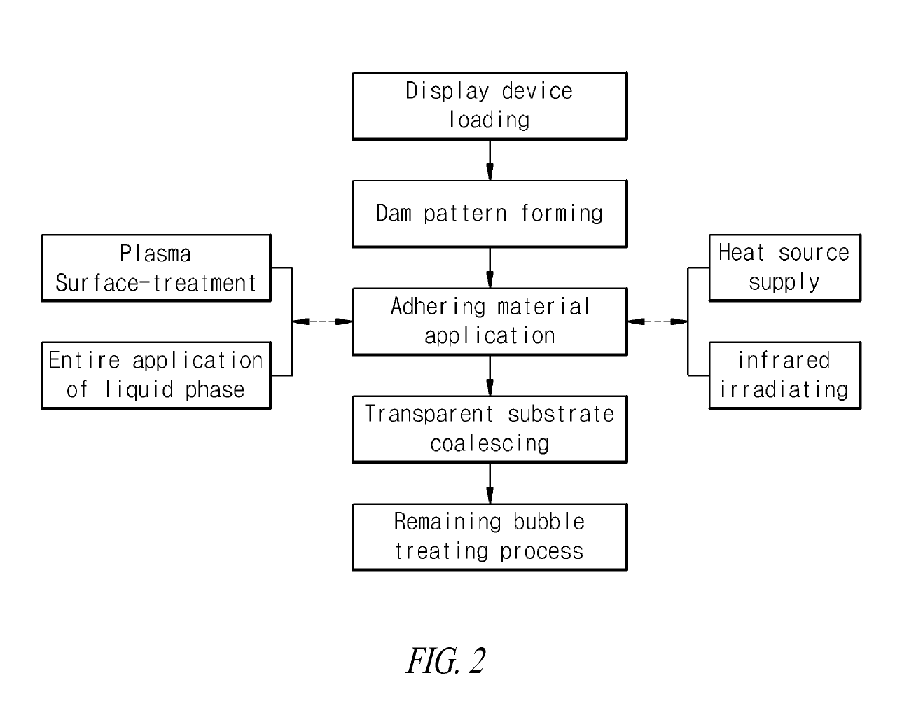

FIG. 2 is a view of showing bubble removing processes in order and FIG. 3 is a view of showing the bubble removing processes in detail according to an embodiment of the present invention.

A coalescing method of a transparent substrate and a display device according the present invention may includes a first step of applying light curing-type dam material to form dam patterns on a surface of the display device, a second step of applying adhesive material inside the dam patterns, and a third step of coalescing the transparent substrate to the adhering material.

Referring to FIG. 2, each step will be described in detail.

1. First Step-Dam Pattern Forming Process

The present invention intends mainly to entirely apply the liquid adhesive agent on the display device such as Liquid Crystal Display (LCD) in order to avoid reflection therefrom and then coalesce the transparent substrate wherein dam patterns may be formed on the display device to apply the liquid adhesive agent efficiently.

Here, the dam patterns refer to as a protruded structure formed on the surface of the display device along a circumference thereof. For this purpose, according to an embodiment of the present invention, the light curing-type dam material of liquid phase as forming the dam patterns may be applied along an outer shell of the display device surface and then light is irradiated for curing the dam material to form the protruded structure. The light curing-type dam material may include a viscosity adjuster, and the viscosity adjuster may be an inorganic filler selected one from a group consisting of silica, alumina, ceria, and titania.

In particular, according to an embodiment of the present invention, the dam patterns as shown in FIG. 3 may be formed. In more detail, as shown in FIG. 3, dam patterns 120 as a plurality of protruded structures may be formed on the outer shell surfaces of the display device 110 through the forgoing processes.

In this case, the dam patterns 120 may be provided with at least one of vent holes X1-X4 and Y1-Y4 so that bubbles may be escaped through the vent holes in a case where the transparent substrate is attached to the display device 110.

Meanwhile, the dam patterns 120 may be formed along a lengthwise direction of an outer peripheral surface as protruded structures cured slightly, having same composition as the liquid adhesive agent, and the dam patterns may be formed as 4 structures on the outer shell surface of the thin film display device along a lengthwise direction thereof wherein at least one of second vent holes Y1-Y4 may be formed on the dam between respective first 4 vent holes X1-X4 formed on each corner and an adjacent first vent hole. In this case, only one second vent hole is formed in each of lengthwise direction and transverse direction; however, more than one of the second vent holes may be formed. Through this arrangement of the vent holes, bubbles may be escaped to several directions and thereby increasing bubble removing efficiency.

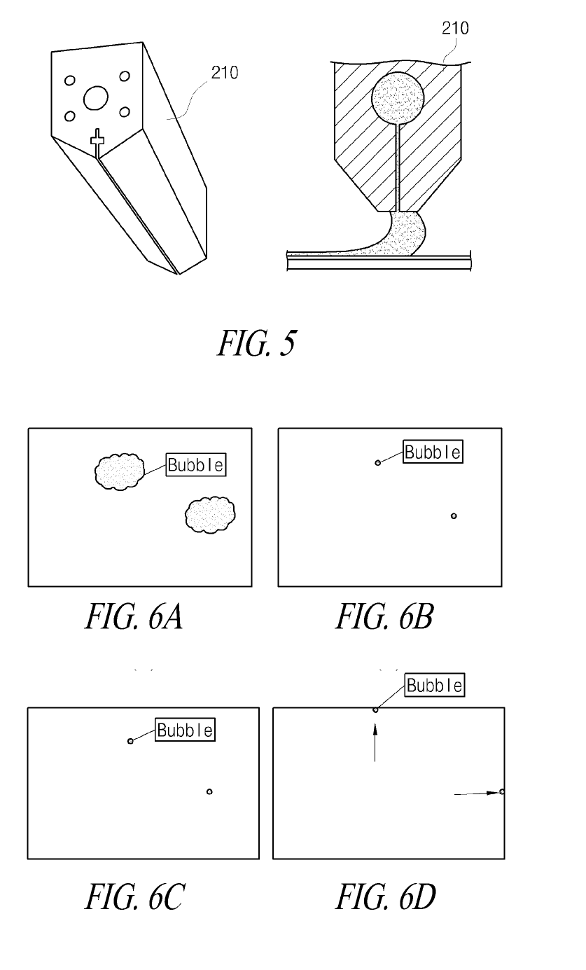

After that, a pattern forming process of the adhering material may be performed to form pattern Z on the surface of the display device 110 of inner side of the dam patterns. Additionally, as shown in FIG. 5, the liquid adhesive agent may be applied through a face application manner, that is, it may be applied from one side to another side in sequence of the display device using a squeezing device 210.

2. Second Step-Adhering Material Application Process

Next, a process of applying the adhering material to the inner side of the dam patterns may be performed. In this case, as set forth in detail in FIG. 3, a process of forming the pattern Z of the liquid adhesive agent on the surface of the display device 110 of inner side of the dam pattern may be performed, or the face application process may be performed using the squeeze device so that the adhering agent is applied from one side to another side in sequence of the display device.

In this case, in consideration of spreadability or spread direction of the adhering material, the face application process of the adhering material may be performed by the pattern application or the face application using the squeezing device for uniform application. Furthermore, in addition to applying the liquid adhesive agent to one face of the transparent substrate or the display device, the liquid adhesive agent may be applied to both of them to be spread rapidly and uniformly. In case of the adhering material being face-applied, the adhering material may be applied uniformly using a roller such as squeezing device to be spread out evenly.

The transparent light curing-type adhering agent may be used as the adhering material used in the second step and further a plasma surface-treatment may be performed on the surface of the display device to remove bubbles to be formed in the application process of the adhering material.

In more detail, the plasma surface-treatment may be performed such that plasma is treated on the surface of the display device to which the transparent substrate is adhered wherein the surface of the display device is treated with a reaction gas of argon gas or nitride gas, or combination gas thereof and thereby increasing wetability of liquid phase (the liquid adhesive agent) on the adhering surface to minimize micro bubble forming

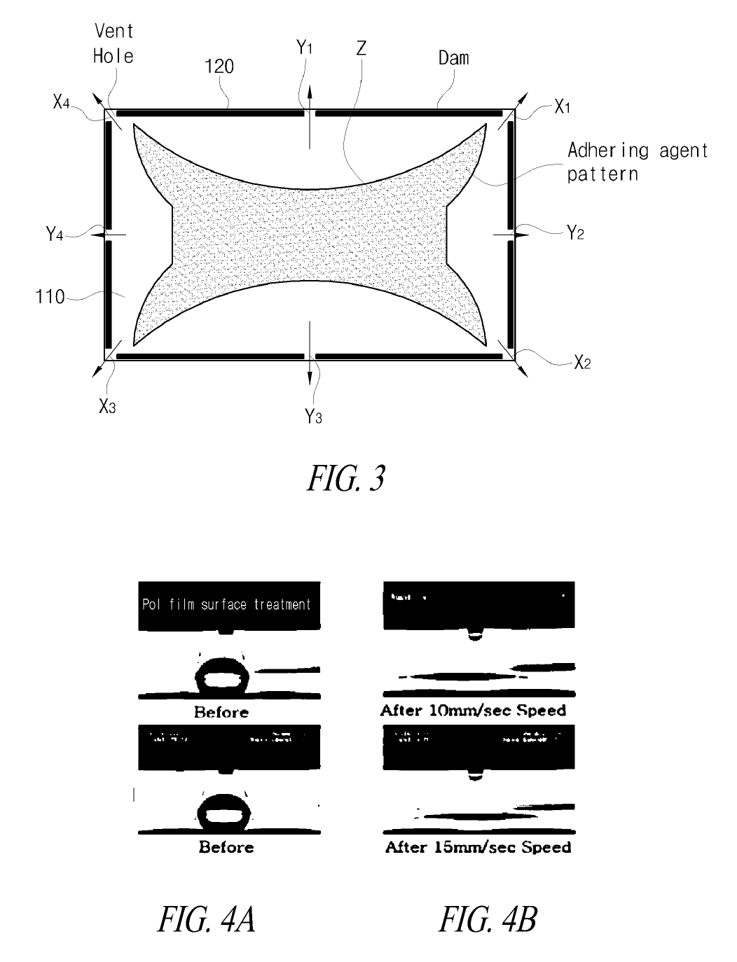

FIG. 4(a) and FIG. 4(b) are images showing comparison of bubble forming before and after the plasma-surface treatment wherein it is shown that the bubble forming is decreased dramatically only through the plasma surface-treatment.

In addition, the application process of the adhering material in this step may be performed at a higher temperature than a room temperature to increase spreadability of the adhering material. In this case, a heat supply module may be further provided on a lower side of the transparent substrate to supply heat to the transparent substrate to increase the spreadability of the liquid adhesive agent. Additionally, an infrared supply module, together with or independently from the heat supply module, may be provided to supply infrared to the adhering material to increase further spreadability of the liquid adhesive agent. Furthermore, the spreadability of the adhering material may be increased by irradiating infrared or supplying heat to the attaching surface of the display device.

3. Third Step-Coalescing Process of Transparent Substrate and Display Device

A coalescing process of the transparent substrate and the display device may be performed in the third step.

In more detail, the transparent substrate may be coalesced to the display device via the applied adhering material, and preferably as shown in FIG. 3, a vacuum-coalescing method may be used to remove the bubbles formed during the application process of the patterned-adhering material and the attaching process of the transparent substrate, or the coalescing method may be performed at a room temperature.

Here, in a case of the vacuum-coalescing method, a product may be damaged in a reduced pressure and thus there is a limitation to removing entirely the bubbles formed on the attaching surface of the cover glass and the display device. In particular, it is further difficult for the bubbles formed from the dissolved oxygen to be removed.

Meanwhile, during the coalescing process the transparent substrate may be vacuum-coalesced or room temperature-coalesced to the surface of the display device, and ultraviolet may be irradiated firstly to a coalesced surface thereof to pre-cure coalesced front surface and side surface and then ultraviolet may be irradiated secondly to main-cure finally the coalesced surfaces, and thereby intending a curing stability and avoiding leakage of the liquid adhesive agent.

As another coalescing method of the transparent substrate and the display device, the adhering material may be applied to the attaching surface of the transparent substrate in addition to the surface of the display device to increase attaching property and then be coalesced.

According to an embodiment of the present invention, uniform spreadability in application of the liquid adhesive agent can be ensured, and thereby increasing an attachment property of the liquid crystal panel and the glass.

4. Fourth Step-Remaining Bubble Removing Process

In the structures of the transparent substrate and the display device coalesced through the third step, there may be remaining bubbles on the coalesced part or remaining bubbles caused from dissolved oxygen inside the adhering material. The remaining bubbles may cause defects later and thus the remaining bubbles have to be removed.

That is, as described in relation to shown in FIG. 3, pressure and heat may be applied to the coalesced product of the cured transparent substrate and the display device for the remaining bubbles in the coalesced surface of the transparent substrate and the display device to be moved outside.

FIG. 6 (a) is an image of the bubble A1 in a vacuum-on state after the vacuum-coalescing, and FIG. 6 (b) is an image of the remaining bubble A2 in a vacuum-off state after the vacuum-coalescing. That is, as described in the forgoing, in a case where the cover is vacuum-coalesced to the surface of the thin film display device, bubbles may be formed decreasingly; however, the bubbles are not removed entirely.

Accordingly, in an autoclave, heat and pressure is applied to the micro bubbles A3 as shown in FIG. 6 (c) for the remaining bubbles A4 to be moved outside the coalesced surface, as shown in FIG. 6(d) and thereby removing the micro bubbles.

This remaining bubble removing process may include further step of moving micro bubbles between the transparent substrate such as the coalesced-glass and the display device outside the coalesced surface through applying heat and pressure in the autoclave and thereby removing the micro bubbles.

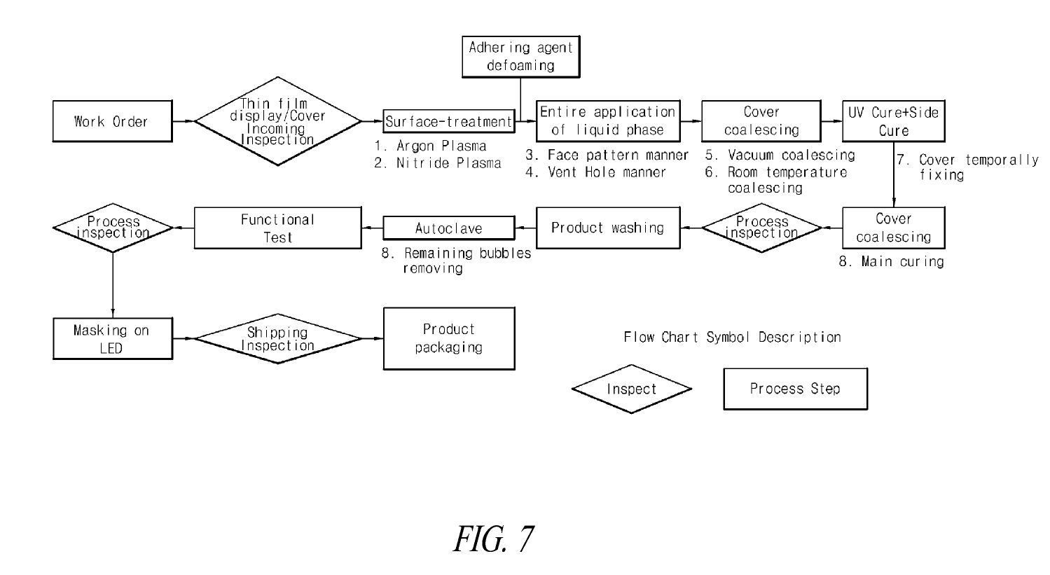

FIG. 7 is a view of showing one process of implementing full auto lines through entire auto-facility for coalescing process according to the present invention.

As shown in FIG. 7, a loading process of the liquid crystal panel such as thin film display and cover glass to be used in the process is performed such a manner that contaminant and defective product are removed through an incoming inspection when they are initially loaded and then plasma-surface treatment process, entire application process of the liquid adhesive agent, transparent substrate (cover) coalescing process, inspection, washing, remaining bubble removing process in the autoclave, inspection and shipping process are performed.

Here, the bubble removing process as set forth in the forgoing according to the present invention may be implemented as a full auto line of continuous process through auto-facility and thereby decreasing dramatically the defective rate caused from bubble forming and insuring price competition through mass production and further implementing innovative productivity through increasing yield.

5. Dam Pattern Forming Apparatus

The dam pattern forming apparatus as used in the first step of coalescing the transparent substrate and the display device according to the present invention is configures as following.

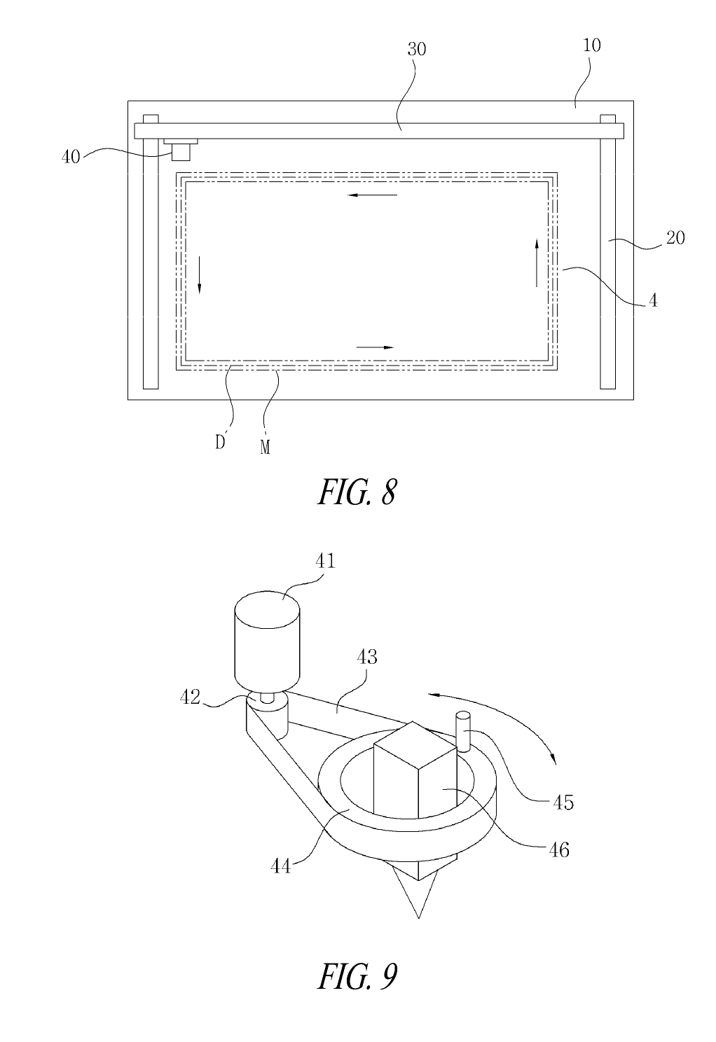

As shown in FIGS. 8 and 9, the dam pattern forming apparatus may include a table 10, rod modules 20, 30 and a dam pattern forming module 40.

The table 10 may be shaped as a flat-plate, and on which the rod module 20 progressing lengthwise and the rod module 30 progressing transversely are arranged. Here, the rod modules 20, 30, which progress lengthwise and transversely, respectively, refer to as general moving means, which may progress to one direction of length and transverse or both directions at the same time along rails through a motor, and thus detailed description thereof is omitted. Here, even though a configuration for progressing vertically is not described, it has known that it can be moved vertically through length and transverse rod modules.

The dam pattern forming module 40 may be provided on the transverse rod module 30 and it may include a driving unit 41, a following part 42, a pulley 43, a rotation unit 44, a curing unit 45 and a sealant discharging unit 46. Here, a sub motor which is rotatable forwardly and backwardly may be used as the driving unit 41 since it may be rotated forwardly and backwardly and also may respond rapidly to a control signal to thereby improve control efficiency.

Referring to a coupling configuration of the dam pattern forming module, the following part 42 is connected to a shaft of the driving unit 41 in order to transmit its rotation force thereto, and the rotation unit 44 is arranged in a state of being spaced at a predetermined interval from the following part and then the rotation unit 44 and the following part 42 are connected through the pulley 43. Accordingly, it has known that outer peripheral surfaces of the following part and the rotation unit are corresponded. Here, a time pulley may be used as the pulley since error of the rotation force transmitted from the driving unit through the pulley can be minimized to the rotation unit.

Meanwhile, the curing unit 45 may be provided at a place spaced from a circumferential center of the rotation unit 44 and further the sealant discharging unit 46 may be provided at a center of the rotation unit.

Referring to an operation of the dam pattern forming apparatus, the rotation force produced by the driving unit rotates the rotation unit through the pulley and the curing unit spaced from a center of the rotation unit is rotated through the rotation unit, based on the sealant discharging unit placed at a center of the rotation unit. At this time, the driving unit may be rotated forwardly and backwardly and thus the curing unit may be placed horizontally at a rear end of the sealant discharging unit, depending on a progressing direction of the sealant discharging unit.

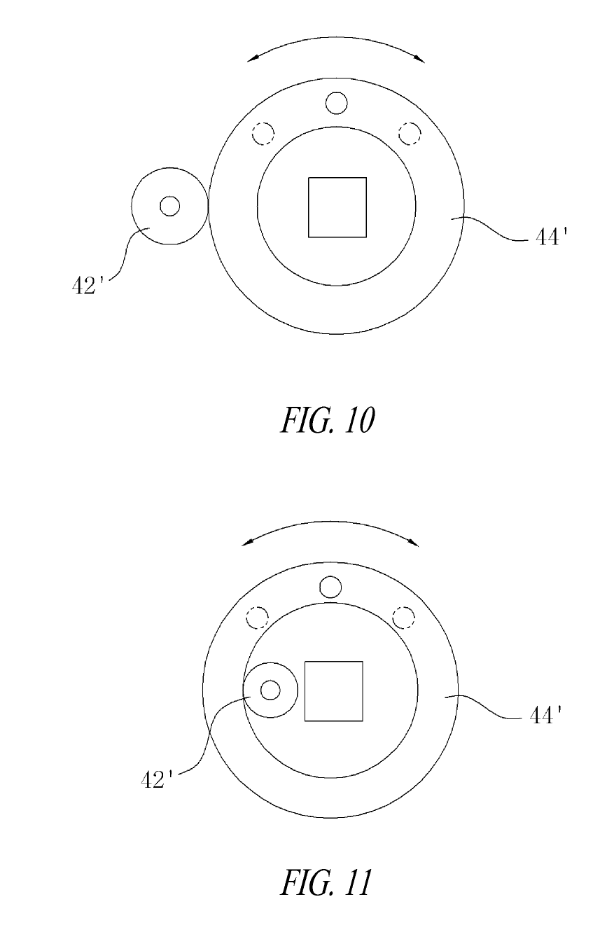

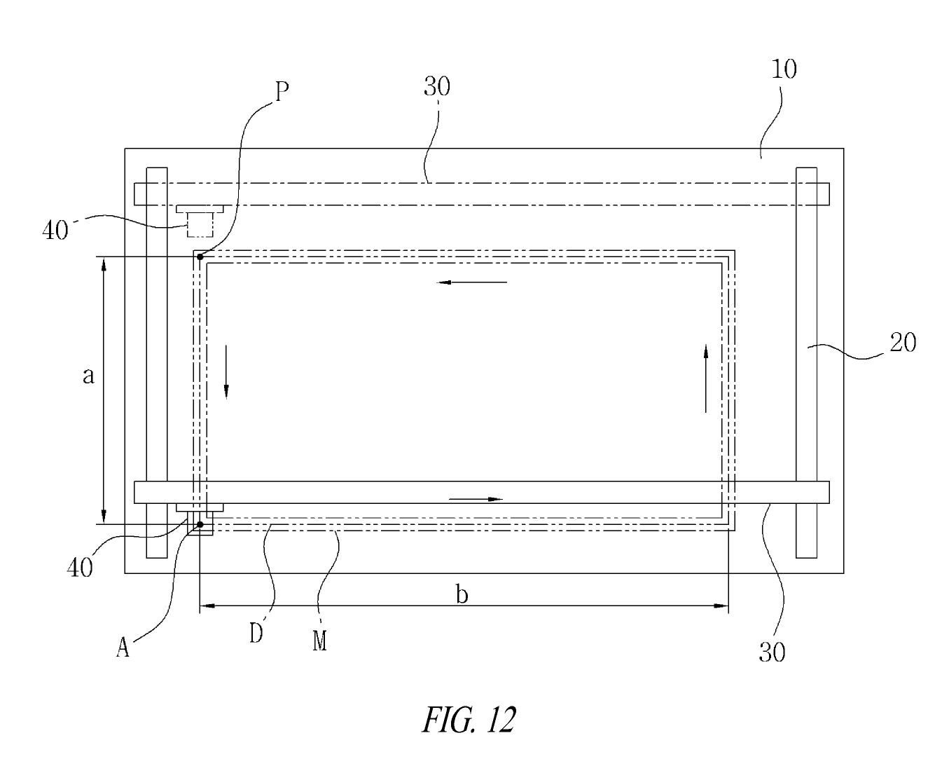

In a configuration as shown in FIGS. 8 and 9, the rotation unit is rotated using the pulley; however, as shown in FIG. 10, a rotation unit 44′ may be rotated using a gearing manner in which outer peripheral faces of a following part 42′ and the rotation unit 44′ are engaged to each other, and further as shown in FIG. 11, the rotation unit may be rotated by the following part 42′ placed inside the following part. That is, any configurations may be adopted on the condition that the rotation unit provided with the curing unit is rotated depending a rotation direction of the sealant unit and is placed horizontally to the sealant discharging unit.

In the following, operations of the present invention will be described, referring to the accompanied drawings.

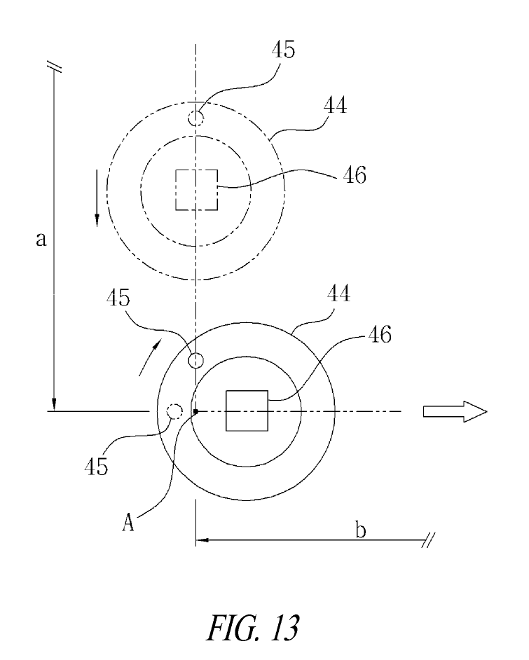

As shown in FIGS. 12 and 13, first, a display module M is seated on a table 10 and then a dam pattern forming apparatus 40 is adjusted through a controller (not shown) to be placed on an edge of the display module M. At this time, a location of the dam pattern forming apparatus may be adjusted lengthwise and transversely using length and transverse rod blocks, respectively, and vertically using a vertical rod block. In a case where the dam pattern forming module 40 is disposed at an adjusted location, pre-setting of location movement direction and size are executed through a controller. That is, since the display module having a large area is defined to a predetermined size, pre-setting thereof is possible. For example, when lengths of around area of 47″ display module are calculated lengthwise and transversely and then each value is inputted in order to form the dam patterns on a display module of 47″, the dam pattern forming module is to be moved depending on signals from the controller.

After setting the moving size of the dam pattern forming module through this manner, when the dam pattern forming module is operated, as shown in FIGS. 12 and 13, it is moved from a starting point P along an interval a, and further the sealant discharging unit 46 injects sealant over the display module. At this time, since a progressing direction of the sealant discharging unit is within the interval a, the curing unit 45 is moved along the injected sealant in a state of being placed at its normal location without being rotated, and thereby curing the sealant.

In this state, when the sealant discharging unit is placed on an edge A of the display module M, it converts its progressing direction from length direction to transverse direction and enters into an interval b.

At this time, the rotation unit receives rotation force through the driving of the driving unit according to the progressing direction conversion of the sealant discharging unit and is rotated without being departed from a location where the sealant being-injected. That is, the sealant discharging unit converts its progressing direction at an edge of the display module and at the same time the rotation unit starts to rotate, corresponding to a progressing speed of the sealant discharging unit, and further when the curing unit arrives at a location of the edge A, the rotation unit stops being rotated and is moved along the sealant injected from the sealant discharging unit and thereby curing the sealant.

Here, a progressing speed of the sealant discharging unit is proportional to a rotation speed of the rotation unit, and thus angular speed of the rotation unit may be defined through integral or differential calculus and the values may be converted into signals using the controller to control the speeds. This control method may be implemented using a general program and thus description thereof is omitted.

According to the present invention, since the curing unit responds actively to a progressing direction of the sealant discharging unit, continuous sealant injection and curing is possible without being stopped at the edge of the display module and thereby forming the dam patterns to be even height and interval and decreasing whole process time through the continuous progressing.

Additionally, moving directions of the dam pattern forming apparatus may be controlled depending on control signals and thereby precise sealant injection and curing thereof is possible.

According to the dam pattern forming apparatus as described in the forgoing, the sealant for forming the dam patterns may be discharged continuously and thereby forming uniformly dam patterns over the display module and shortening whole process time and increasing yield. In addition, according to the present invention, the dam pattern forming apparatus may be moved right angularly at an edge of the display module, and thus dam patterns may be formed continuously at an edge of the display module.

According to the present invention, there are some technical advantages that bubbles produced during a attaching process of a transparent substrate and a display device and bubbles caused from dissolved oxygen inside an adhering agent, which may cause bubble defects when an liquid adhesive agent is applied entirely on a display device for avoiding reflection, are removed completely through a plasma treatment, application process treatment and autoclave treatment, and thereby implementing reliable product, full automatic process and maximizing productivity.

Additionally, there are also technical effects that a liquid adhesive agent is applied to both of a transparent substrate and a display device for an efficient application process of the liquid adhesive agent and thereby improving adhering property of the transparent substrate and the display device, or improving spreadability of the liquid adhesive agent through heat supply or infrared irradiation.

While the invention has been shown and described with reference to exemplary embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

What is claimed is:

1. A method of coalescing a transparent substrate and a display device comprising:
a first step of applying light curing-type dam material on a surface of the display device and forming dam patterns thereon;
a second step of applying adhering material inside the dam patterns; and
a third step of coalescing the transparent substrate on the adhering material.

2. The method of claim 1, wherein the first step comprises applying the light curing-type liquid dam material along an outer shell of the surface of the display device and irradiating light thereto and thereby curing the dam material.

3. The method of claim 2, wherein the first step comprises forming the dam patterns in which at least one vent hole is formed on an outer peripheral surface of the display device.

4. The method of claim 3, wherein the dam patterns are formed lengthwise on the outer shell surface of the display device as protruded patterns, and at least one of second vent holes are formed on the dam between two adjacent first vent holes among 4 first vent holes formed on corners of the display device.

5. The method of claim 2, wherein the light curing-type dam material comprises a viscosity adjuster.

6. The method of claim 5, wherein the viscosity adjuster is an inorganic filler.

7. The method of claim 6, wherein the inorganic filler is one selected from a group consisting of silica, alumina, ceria and titania.

8. The method of claim 1, wherein the second step comprises using transparent light curing-type adhering agent as the adhering material.

9. The method of claim 8, wherein the second step comprises treating a surface of the display device with plasma and then applying the adhering material thereto.

10. The method of claim 9, wherein the second step comprises treating a surface of the display device with plasma using argon gas or nitride gas, or combination thereof as a reaction gas.

11. The method of claim 9, wherein the second step further comprises irradiating infrared to the liquid adhesive agent after the liquid adhesive agent is applied.

12. The method of claim 9, wherein the second and third steps are performed at higher temperature than a room temperature.

13. The method of claim 12, wherein the third step comprises applying the adhering material on the transparent substrate and coalescing it to the adhering material on a surface of the display device.

14. The method of claim 13, wherein in the third step, the transparent substrate further comprises an anti-reflection layer.

15. The method of claim 13, wherein the transparent substrate is seated on front portion of the display device and the transparent substrate and the display device are coalesced by light-curing the adhering material.

16. The method of claim 13, wherein the third step comprises:
vacuum-coalescing or room temperature-coalescing the transparent substrate to a surface of the display device;
irradiating ultraviolet to the coalesced surface for pre-curing a front surface or side to be coalesced; and
irradiating ultraviolet thereto to main-cure the coalesced surface.

17. The method of claim 16, which further comprises, after the third step, a fourth step of applying heat or pressure to the coalesced part of the transparent substrate and the display device to remove remaining bubbles.

18. A dam pattern forming apparatus for coalescing a transparent substrate and a display device, comprising:
a table on which a display device is seated;
a rod module which is provided on the table and is moved along circumferential surface of the display device; and
a dam forming module which is provided on the rod module and is moved continuously along entire circumferential surface of the seated display device to discharge and cure the sealant simultaneously.

19. The dam pattern forming apparatus of claim 18, wherein the dam forming module comprises:
a sealant discharging unit;
a curing unit for curing the discharged sealant; and
a rotation unit for moving the curing unit along the discharged sealant through forward or backward rotation.

20. The dam pattern forming apparatus of claim 19, wherein the rotation unit is rotated by an adjacent driving unit and the rotation unit and the driving unit is connected through a pulley.

21. The dam forming apparatus of claim 20, wherein the rotation unit is rotated by the adjacent driving unit and the rotation unit and the driving unit is connected through a gear set.

22. The dam forming apparatus of claim 21, wherein the gear set is rotated through an engagement with outside or inside of the rotation unit.
